(19) United States
(12) Patent Application Publication
(10) Pub. No.: US 2009/0146565 A1
(43) Pub. Date: Jun. 11, 2009

(54) Barrier ribs, plasma display panel including the same, and associated methods

(76) Inventor: Chong-Gi Hong, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/289,443

(22) Filed: Oct. 28, 2008

(30) Foreign Application Priority Data
Dec. 5, 2007 (KR) 10-2007-0125758

(51) Int. Cl. H01J 17/49; H01J 9/20; B32B 5/00

(52) U.S. Cl. 313/582; 445/24; 428/156

(57) ABSTRACT

A plasma display panel (PDP) includes a first substrate, a second substrate facing the first substrate, inner barrier ribs in a display region of the PDP between the first substrate and the second substrate to define discharge cells, at least one dummy barrier rib in a non-display region of the PDP between the first substrate and the second substrate, the non-display region being external to the display region, and the dummy barrier rib including at least one curved end portion and a cavity in the curved end portion, discharge electrodes between the first substrate and the second substrate to generate a discharge in the discharge cells, and at least one phosphor layer in each discharge cell.

### BACKGROUND OF THE INVENTION

1. Field of the Invention

Embodiments of the present invention relate to a plasma display panel (PDP). More particularly, embodiments of the present invention relate to a method of forming barrier ribs and to a PDP including the same.

2. Description of the Related Art

A PDP may display images by applying voltage via electrodes to a discharge gas in discharge cells between two substrates to generate ultraviolet (UV) light, so the UV light may excite phosphor layers in the discharge cells to trigger emission of visible light. The discharge cells may be defined by barrier ribs between the two substrates, e.g., front and bottom substrates. The barrier ribs may include inner barrier ribs in a display region of the PDP, i.e., a region displaying images, and dummy barrier ribs in a non-display region, i.e., a region outside the display region.

Generally, the barrier ribs may be formed by patterning a dried barrier rib material into a predetermined structure. For example, a rectangular mask may be positioned on the dried barrier rib material, so the barrier rib material may be sandblasted through the rectangular mask to form barrier rib structures corresponding to the rectangular mask, followed by baking the barrier rib structures to form barrier ribs. Sandblasting may include spreading sand particles at a large speed in a downward direction through a nozzle to remove portions of barrier ribs material.

During sandblasting, however, an excessive amount of barrier rib material may be removed to undercut the barrier rib structures, e.g., undercut edges of dummy rib structures in the non-display region. In particular, barrier rib structures at edges of the non-display region may have a larger surface area exposed to the sandblasting than other barrier rib structures, e.g., inner barrier rib structures, so larger portions of the barrier rib material at edges of the non-display region may be removed. In addition, the sand particles directed in a downward direction may bounce back in an upward direction to collide with other sand particles, so a direction of some of the sand particles may be changed, e.g., along a direction parallel to the substrates, thereby undercutting edges of the barrier rib structures, e.g., dummy barrier rib structures.

Undercut barrier rib structures may deform during the baking. In particular, undercut barrier rib structures may include portions of dried barrier rib material overhanging the undercut portions. During baking, binder evaporation from the barrier rib structures may cause shrinkage of the barrier rib structures. The undercut portions, however, may prevent shrinkage of the dried barrier rib material overhanging the undercut portions, thereby causing protrusion of such portions, e.g., away from the bottom substrate. Barrier ribs with such non-uniform structure, i.e., barrier ribs with portions protruding away from the bottom substrate, may cause unstable connection between the dummy barrier ribs and a front panel of the PDP, thereby generating vibration and noise during operation of the PDP.

### SUMMARY OF THE INVENTION

Embodiments of the present invention are therefore directed to a method of forming barrier ribs and to a PDP including the same, which substantially overcome one or more of the disadvantages of the related art.

It is therefore a feature of an embodiment of the present invention to provide a method of forming barrier ribs without undercut portions.

It is therefore another feature of an embodiment of the present invention to provide a PDP with barrier ribs having improved structure.

It is yet another feature of an embodiment of the present invention to provide a PDP having reduced vibrations and noise.

At least one of the above and other features and advantages of the present invention may be realized by providing a PDP, including a first substrate, a second substrate facing the first substrate, inner barrier ribs in a display region of the PDP between the first substrate and the second substrate to define discharge cells, at least one dummy barrier rib in a non-display region of the PDP between the first substrate and the second substrate, the non-display region being external to the display region, and the dummy barrier rib including at least one curved end portion and a cavity in the curved end portion, discharge electrodes between the first substrate and the second substrate to generate a discharge in the discharge cells, and at least one phosphor layer in each discharge cell.

The curved end portion of the dummy barrier rib may have an oval shape, and the cavity is in a center of the curved end portion. The curved end portion of the dummy barrier rib may have an oval shape, and the cavity may be off-centered. The cavity may be between a center of the curved end portion and a linear body attached to the curved end portion. The curved end portion of the dummy barrier rib may have a circular shape, and the cavity may be in a center of the curved end portion or between the center and a linear body attached to the curved end portion. The PDP may further include a plurality of dummy barrier ribs in parallel to one another, the curved end portions of the dummy barrier ribs being aligned horizontally or vertically. The PDP may further include a plurality of dummy barrier ribs in parallel to one another, the curved end portions of the dummy barrier ribs being arranged in a zigzag. The PDP may further include a plurality of dummy barrier ribs in parallel to one another, the curved end portions of the dummy barrier ribs being arranged in a diagonal line. The curved end portion of the dummy barrier rib may be attached to a linear body, a width of the curved end portion being greater than a width of the linear body. The curved end portion of the dummy barrier rib may be attached to a linear body, heights of the curved end portion and the linear body being substantially equal. The PDP may further include a plurality of dummy barrier ribs in parallel to one another, a width of an outermost dummy barrier rib being greater than a width of each of the other dummy barrier ribs.

At least one of the above and other features and advantages of the present invention may be also realized by providing a mask for forming barrier ribs of a PDP, including at least one barrier rib pattern with a linear body, at least one curved end portion attached to the linear body, and a cavity in the curved end portion.

At least one of the above and other features and advantages of the present invention may be also realized by providing a method of forming a PDP, including forming inner barrier ribs in a display region of the PDP between facing first and second substrates to define discharge cells, forming at least one dummy barrier rib in a non-display region of the PDP between the first and second substrates, the non-display region being external to the display region, and the dummy barrier rib including at least one curved end portion and a cavity in the curved end portion, forming discharge electrodes between the first and second substrate, and forming at least one phosphor layer in each discharge cell.

Forming the dummy barrier rib may include forming a plurality of dummy barrier ribs in a stripe pattern. Forming the dummy barrier rib may include shaping the curved end portions of the dummy barrier ribs to have oval shapes or circular shapes, and forming the cavity in a center of the curved end portion or between the center and a linear body attached to the curved end portion. Forming the dummy barrier rib may include forming a dummy barrier rib patterning mask on a barrier rib material, the dummy barrier rib patterning mask including at least one curved end portion and a cavity in the curved end portion. Forming the dummy barrier rib may further include removing portions of the barrier rib material surrounding the dummy barrier rib patterning mask, such that portions of the barrier rib material under the dummy barrier rib patterning mask is shaped to correspond to the dummy barrier rib patterning mask, and removing the dummy barrier rib patterning mask. Forming the dummy barrier rib patterning mask may include forming a plurality of patterns with curved end portions, the curved end portions being aligned vertically, horizontally, diagonally or in a zigzag. Forming the dummy barrier rib patterning mask may include forming a plurality of patterns with curved end portions, a width of each curved end portion being larger than a width of any other portion of a respective pattern. Forming the dummy barrier rib patterning mask may include forming a plurality of patterns, a width of an outermost pattern of the plurality of patterns being greater than a width of any other pattern.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a plan view of barrier rib patterning masks of a PDP according to an embodiment of the present invention;

FIG. 2 illustrates an enlarged view of area B in FIG. 1;

FIG. 3 illustrates a schematic view of a pattern in a dummy barrier rib patterning mask of FIG. 1;

FIG. 4 illustrates a schematic view of a pattern in a dummy barrier rib patterning mask according to another embodiment of the present invention;

FIG. 5 illustrates an arrangement of patterns in a dummy barrier rib patterning mask according to an embodiment of the present invention;

FIG. 6 illustrates an arrangement of patterns in a dummy barrier rib patterning mask according to another embodiment of the present invention;

FIGS. 7A-7C illustrate sequential stages in a method of forming dummy barrier ribs according to an embodiment of the present invention;

FIGS. 8A-8D illustrate sequential stages in a comparative method of forming dummy barrier ribs;

FIGS. 9A-9B illustrate scanning electron microscope (SEM) images of cross-sections of inner and dummy barrier ribs, respectively, formed according to an embodiment of the present invention; and

FIGS. 10A-10B illustrate SEM images of cross-sections of inner and dummy barrier ribs, respectively, formed using the comparative method of FIGS. 8A-8D; and

FIG. 11 illustrates a view of a PDP according to an embodiment of the present invention.

### DETAILED DESCRIPTION OF THE INVENTION

Korean Patent Application No. 10-2007-0125758, filed on Dec. 5, 2007, in the Korean Intellectual Property Office, and entitled: “Plasma Display Panel and Method of Forming Barrier Rib,” is incorporated by reference herein in its entirety.

Exemplary embodiments of the present invention will now be described more fully hereinafter with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of elements and regions may be exaggerated for clarity of illustration. It will also be understood that when an element is referred to as being “on” another element or substrate, it can be directly on the other element or substrate, or intervening elements may also be present. Further, it will be understood that the term “on” can indicate solely a vertical arrangement of one element with respect to another element, and may not indicate a vertical orientation, e.g., a horizontal orientation. In addition, it will also be understood that when an element is referred to as being “between” two elements, it can be the only element between the two elements, or one or more intervening elements may also be present. Like reference numerals refer to like elements throughout.

Hereinafter, an exemplary embodiment of a PDP with barrier ribs formed according to an embodiment of the present invention will be described in more detail below with reference to FIG. 11.

As illustrated in FIG. 11, a PDP 200 may include a front panel 201 and a rear panel 202 adhered to each other. The front panel 201 may include a front substrate 2, first discharge electrodes 4, a front dielectric layer, and a protective layer. The first discharge electrodes 4 may be formed on the front substrate 2, and may be embedded in the front dielectric layer. The protective layer may be coated on the front dielectric layer to protect the front dielectric layer. The rear panel 202 may include a bottom substrate 1, second discharge electrodes 7, a bottom dielectric layer, barrier ribs to define discharge cells 12, and phosphor layers 13 in the discharge cells 12. The second discharge electrodes 7 may be formed on the bottom substrate 1, and may be embedded in the bottom dielectric layer. The bottom substrate 1 may be formed of a glass material.

The barrier ribs may be formed on the bottom substrate 1, e.g., on the bottom dielectric layer. The barrier ribs may include inner barrier ribs 16 and dummy barrier ribs (not shown). The inner barrier ribs 16 may be formed in a display region D of the PDP 200 to define the discharge cells 12 in a space between the front and rear panels 201 and 202, so a discharge may be generated between the first and second discharge electrodes 4 and 7 in the discharge cells 12. The inner barrier ribs 16 may prevent discharge interference between adjacent discharge cells 12. The dummy barrier ribs may be peripheral to the inner barrier ribs 16, and may be formed in a non-display region N of the PDP 200 surrounding the display region D.

The barrier ribs may be formed, e.g., by a sandblasting method. First, a barrier rib material, e.g., a barrier rib paste, may be coated on a bottom substrate to form a barrier rib paste layer, followed by drying. A photosensitive material, e.g., a dry film resistor (DFR), may be laminated on the dried barrier rib paste layer. Next, UV light may be radiated on the photosensitive material, e.g., via a photo mask having predetermined patterns, to cure portions of the photosensitive material. The cured portions of the photosensitive material may be weakened by the UV light, so application of a developing solution to the photosensitive material may remove the cured portions of the photosensitive material. Accordingly, non-cured portions of the photosensitive material may remain to form a mask for patterning the barrier ribs. Once the mask for patterning the barrier ribs is formed on the barrier rib paste layer, sandblasting may be performed through the mask to shape the barrier rib paste layer into the barrier ribs. Different masks may be used to form the inner barrier ribs 16 and the dummy barrier ribs.

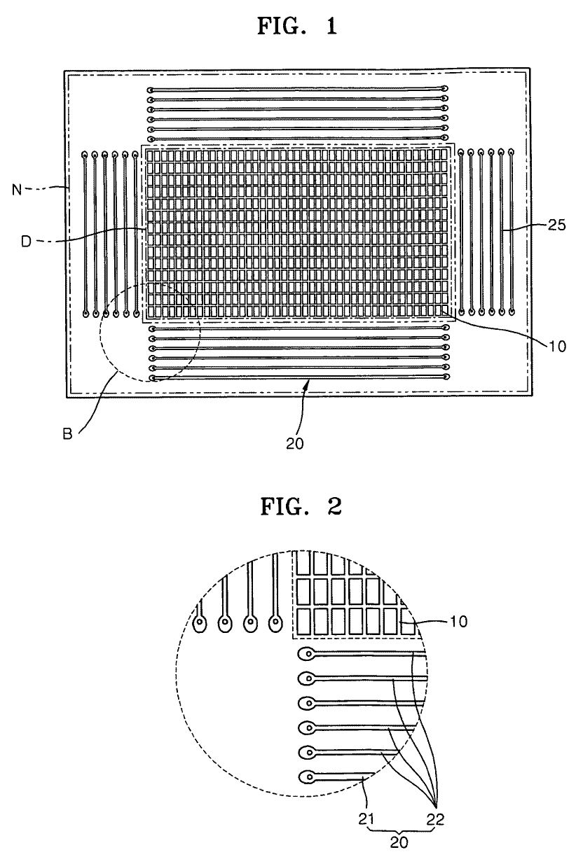

FIG. 1 illustrates a plan view of inner and dummy barrier rib masks for the PDP 200 according to an embodiment of the present invention. Referring to FIG. 1, an inner barrier rib patterning mask 10 may include a plurality of patterns used to form the inner barrier ribs 16 in the display region D of the PDP 200, and may have any suitable structure, e.g., the plurality of patterns may be configured in a matrix structure or in a stripe pattern. First and second dummy barrier rib patterning masks 20 and 25 may include a plurality of patterns used to form the dummy barrier ribs in the non-display region N of the PDP 200, and may have any suitable structure, e.g., the plurality of patterns may be configured in a stripe pattern. The non-display region N of the PDP 200 may be external to the display region D, e.g., the non-display region N may include a plurality of portions surrounding the display region D.

As illustrated in FIG. 1, patterns of the first dummy barrier rib patterning mask 20 may be longer than patterns of the second dummy barrier rib patterning mask 25. Accordingly, the first dummy barrier rib patterning mask 20 may extend along long sides of the bottom substrate of the PDP 200, e.g., may extend horizontally along upper and lower portions of the non-display region N illustrated in FIG. 1. The second dummy barrier rib patterning mask 25 may extend along short sides of the bottom substrate of the PDP 200, e.g., may extend perpendicularly to the first dummy barrier rib patterning mask 20 in the non-display region N. Accordingly, the first and second dummy barrier rib patterning masks 20 and 25 may surround the inner barrier rib patterning mask 10, as further illustrated in FIG. 1. The numbers and positions of patterns in each of the first and second dummy barrier rib patterning masks 20 and 25 may be adjusted according to design and specifications of the PDP 200. For example, as illustrated in FIG. 1, the first dummy barrier rib patterning mask 20 may include six patterns spaced apart and parallel to each other, e.g., arranged in a stripe pattern, along a lower portion of the non-display region N. It is noted that a stripe pattern may provide higher exhaustion efficiency, e.g., during a sandblasting process, than other configurations, e.g., a matrix pattern, so dummy barrier ribs formed to have a stripe pattern with the first and second barrier ribs patterning masks 20 and 25 may have improved structure and exhaustion efficiency, thereby extending lifetime of the PDP 200 and reducing uniformity deterioration of the PDP 200 due to fatigue.

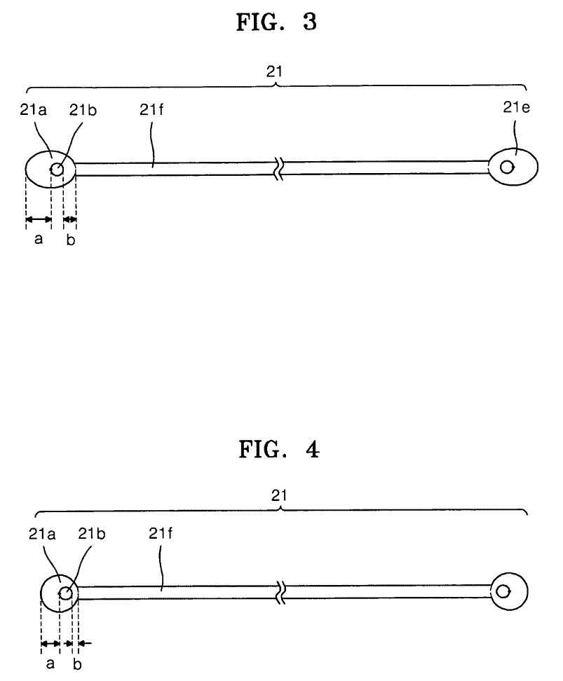

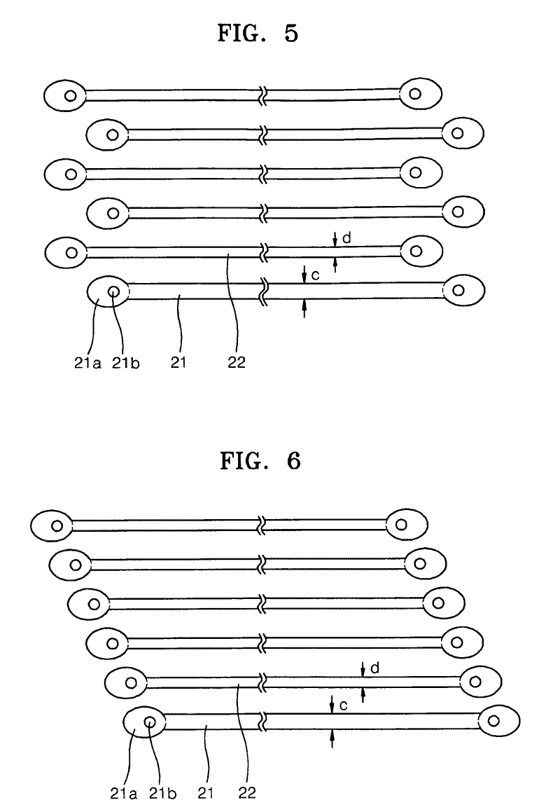

FIG. 2 illustrates an enlarged view of area B in FIG. 1. FIG. 3 illustrates an enlarged schematic view of a single pattern of the first dummy barrier rib patterning mask 20 according to an embodiment of the present invention. FIG. 4 illustrates an enlarged schematic view of a single pattern of the first dummy barrier rib patterning mask 20 according to another embodiment of the present invention. FIG. 5 illustrates an arrangement of patterns in the dummy barrier rib patterning mask 20 according to an embodiment of the present invention. FIG. 6 illustrates an arrangement of patterns in the dummy barrier rib patterning mask 30 according to another embodiment of the present invention. It is noted that only patterns of the first dummy barrier rib patterning mask 20 are described hereinafter for convenience only, and patterns of the second dummy barrier rib patterning mask 25 may have a substantially similar structure to the patterns of the first dummy barrier rib patterning mask 20 with the exception of length and orientation as described previously.

Referring to FIGS. 2-3, the first dummy barrier rib patterning mask 20 may include a plurality of inner patterns 22 and an outermost pattern 21. The outermost pattern 21 may be a most external pattern of the first dummy barrier rib patterning mask 20 with respect to the inner patterns 22. The outermost pattern 21 may be an outermost pattern of the dummy barrier rib patterning mask 20, and may have a linear body with a width “c,” as illustrated in FIGS. 5-6. The plurality of inner patterns 22, as further illustrated in FIGS. 5-6, may have a linear body with a width “d” that may be smaller than the width “c” of the outermost pattern 21. The outermost pattern 21 may have a larger width in order to an outermost dummy barrier rib 14 with an increased width. An outermost dummy barrier rib 14 may have a larger exposure to sand particles than each of the inner dummy barrier ribs 14, so larger portions of the outermost dummy barrier rib 14 may be removed as compared to inner dummy barrier ribs 14. Thus, since the width “c” of the outermost pattern 21 is greater than the width “d” of each of the inner patterns 22, the width of the outermost dummy barrier rib 14 formed by sandblasting may be larger than each of the inner dummy barrier ribs 14.

As illustrated in FIGS. 2-3, each one of the inner patterns 22 and outermost pattern 21 may include a linear body 21f between a first end portion 21a and a second end portion 21e. In particularly, the first and second end portion 21a and 21e may be formed on respective opposite edges of the linear body 21f, so the linear body 21f may extend between the first end portion 21a and the second end portion 21e. Thus, when the sandblasting process is performed, the plurality of inner patterns 22 and outermost pattern 21 may be formed parallel to one another, so the first and second end portions 21a and 21e may be respectively aligned. For example, as illustrated in FIG. 2, the plurality of inner patterns 22 and outermost pattern 21 may extend along the horizontal direction and may be parallel to each other, so their first end portions 21a may be aligned to form a column along a vertical direction. The column of the first end portions 21a may be aligned with an edge of the inner barrier rib patterning mask 10, as further illustrated in FIG. 2.

In another example, as illustrated in FIG. 5, the inner patterns 22 and the outermost pattern 21 may be arranged in an alternating parallel pattern, so the first end portions 21a may be arranged in a zigzag. In other words, the inner patterns 22 and the outermost pattern 21 may be offset horizontally with respect to each other, so, e.g., each inner pattern 22 may be offset horizontally in a same direction with respect to both inner patterns 22 immediately adjacent thereto. In yet another example, as illustrated in FIG. 6, the inner patterns 22 and the outermost pattern 21 may be arranged in a diagonal pattern, so the first end portions 21a may be arranged along a diagonal line. By arranging the first end portions 21a in a zigzag or a diagonal line, the dummy barrier ribs 14 may be formed relatively close to each other without interference therebetween despite relatively large widths of the first and second end portions 21a and 21e.

As illustrated in FIGS. 3-4, the first and second end portions 21a and 21e may be curved. In particular, the first and second end portions 21a and 21e may have any suitable convex structure, i.e., a structure protruding outwardly with respect to the linear body 21f along a plane parallel to the front substrate when viewed from any direction. In other words, widths of the first and second end portions 21a and 21e of the pattern 21, i.e., a distance as measured along a direction perpendicular to a direction of the linear body 21f, may be greater than a width of the linear body 21f. In addition, the first and second end portions 21a and 21e may protrude outwardly along the horizontal direction. For example, as illustrated in FIG. 3, the first and second end portions 21a and 21e may be oval-shaped. In another example, as illustrated in FIG. 4, the first and second end portions 21a and 21e may be circular. However, the present invention is not limited thereto.

A cavity 21b may be formed in the first end portions 21a and/or in the second end portion 21e. As illustrated in FIGS. 3-4, the cavity 21b may be formed off-center in the first and/or second end portions 21a and 21e. In particular, the cavity 21b may be formed closer to the linear body 21f than to an external edge of a respective end portion 21a or 21e. For example, as further illustrated in FIGS. 3-4, a horizontal distance “a” between the cavity 21b and an external edge of the first end portion 21a may be larger than a horizontal distance “b” between the cavity 21b and the linear body 21f. It is noted that structural details of the plurality of inner patterns 22 and the outermost pattern 21 may be substantially similar to each other, with the exception of widths thereof, i.e., a distance as measured along a direction perpendicular to the inner patterns 22 and the outermost pattern 21, as was discussed previously with reference to FIGS. 5-6.

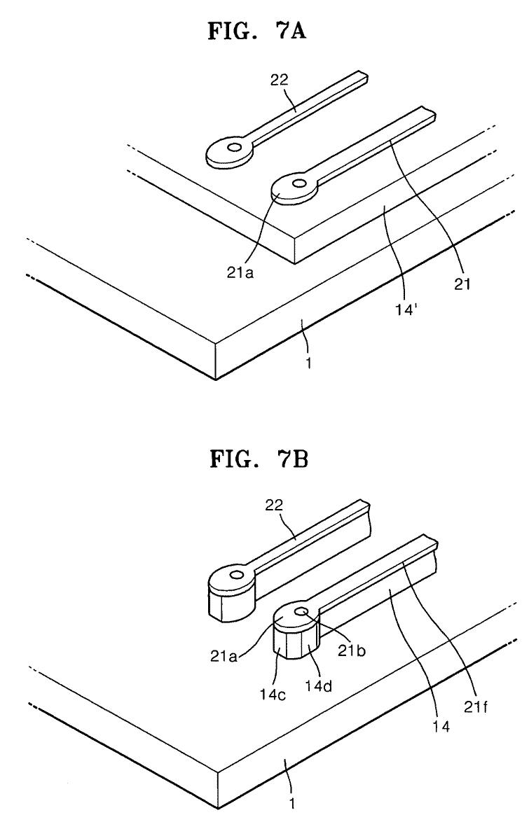

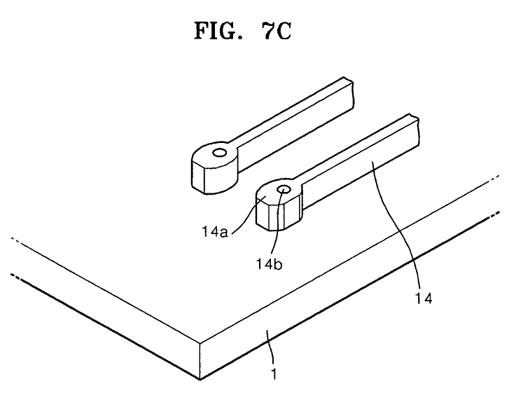

FIGS. 7A-7C illustrate sequential stages in a method of forming the dummy barrier ribs 14 with the dummy barrier rib patterning mask 20 according to an embodiment of the present invention. As illustrated in FIG. 7A, the dummy barrier rib patterning mask 20 may be formed on the barrier rib material 14′, so a plurality of inner patterns 22 and outermost pattern 21 may be positioned on the barrier rib material 14′. The barrier rib material 14′ may be sandblasted via the dummy barrier rib patterning mask 20 to remove portions of the barrier rib material 14′ to form the barrier ribs 14. Once a plurality of barrier ribs 14 corresponding to the patterns 21 is formed, as illustrated in FIG. 7B, the dummy barrier rib patterning mask 20 may be removed, as illustrated in FIG. 7C.

As further illustrated in FIG. 7C, each barrier rib 14 may include an end portion 14a corresponding to an end portion 21a of a respective pattern 21. In particular, since the first end portion 21a of the pattern 21 is convex, i.e., curved outwardly, during the sandblasting process the barrier rib material 14′ may be cut to have convex portions corresponding to the first end portion 21a of the pattern 21. As such, the resultant barrier ribs 14 may not be undercut. For example, the end portion 14a of each barrier rib 14 may include first and second convex portions 14c and 14d, as illustrated in FIG. 7B. The first and second convex portions 14c and 14d may be cut during the sandblasting process to protrude outwardly, so undercutting, e.g., cutting in an inward direction toward a center of the end portion 14a, may not happen.

Further, as illustrated in FIG. 7C, each dummy barrier rib 14 may be formed to include a cavity 14b corresponding to the cavity 21b of the pattern 21. If a substrate is moved at an early stage of the sandblasting process, the end portion 14a of the dummy barrier rib 14 may be exposed to stronger sandblasting impact due to its peripheral position. Formation of the cavity 14b in the end portion 14a of the dummy barrier rib 14 may facilitate dispersion of sand particles, so impact of sandblasting on portions other than the end portion 14a may be prevented or substantially minimized. In other words, formation of the cavity 14b via the cavity 21b may prevent distortion of a curved end portion 14a of the dummy barrier rib 14, i.e., the end portion 14a of the dummy barrier rib 14 may be distorted if the cavity 21b is not present.

The cavity 14b in the end portion 14a may correspond to a position of the cavity 21b in the first end portion 21a, e.g., may be determined according to a cutting degree of the end portion 14a of the dummy barrier rib 14 by sand particles. Accordingly, the cavity 14b in the end portion 14a of the dummy barrier rib 14 may be closer to a linear portion of the barrier rib 14, i.e., a portion corresponding to the linear body 21f of the pattern 21, than to an external edge of the end portion 14a. For example, the cavity 14b of the dummy barrier rib 14 may be disposed in the center of the end portion 14a of the dummy barrier rib 14 or may be off-centered toward the linear portion of the dummy barrier rib 14.

Thus, when the sandblasting process and the baking are performed, the cavity 14b may be formed in the center of an end portion 14a shaped like an oval or a circle, so durability of the dummy barrier rib 14 may be substantially increased. In particular, during baking of the dummy barrier ribs 14, all portions of the barrier ribs 14, i.e., end portions 14a and linear portions, may shrink at a substantially same rate, so heights of the end portions 14a and the linear portions may be substantially uniform. In other words, end portions 14a may not protrude in an upward direction relatively to the linear portions, so failure of the dummy barrier ribs 14 may be substantially reduced to increase stability of the dummy barrier ribs 14.

### EXAMPLES

### Example 1

a first PDP was manufactured with barrier ribs formed according to an embodiment of the present invention, i.e., barrier ribs having curved end portions. In particular, the barrier ribs of the first PDP were formed by using the first and second dummy barrier rib patterning masks 20 and 25 and the inner barrier rib patterning mask 10 according to an embodiment of the present invention, so the dummy barrier ribs were formed to have curved end portions as described previously with reference to FIGS. 7A-7C.

### Comparative Example 1

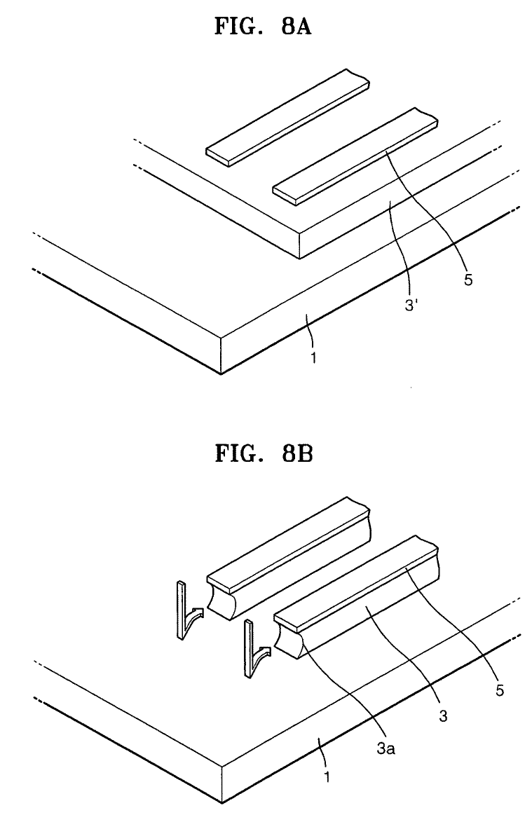

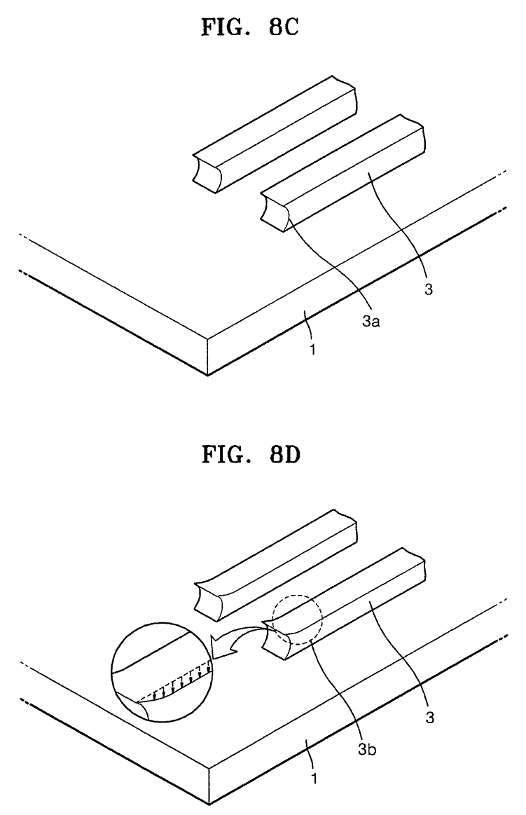

a second PDP was manufactured with rectangular barrier ribs, i.e., having no curved end portions. The barrier ribs of the second PDP were formed via a substantially same method as the barrier ribs of the first PDP, with the exception of using different patterning masks. As illustrated in FIG. 8A, the barrier ribs of the second PDP were formed by using a rectangular patterning mask 5 on a barrier paste layer 3′, i.e., mask with patterns having a rectangular cross-section in each plane. Sandblasting along a direction of the arrows, as illustrated in FIG. 8B, formed an undercut portion 3a in each resultant barrier rib 3, as illustrated in FIG. 8C. Accordingly, when the barrier ribs 3 were baked, an upper portion 3b overhanging the undercut portion 3a of each barrier rib 3 was lifted upward to protrude away from the undercut portion 3a, as illustrated in FIG. 8D. The upper portion 3b was lifted upward because binder in the barrier rib paste evaporated during baking, thereby causing portions of the barrier rib 3 other than the upper portion 3b to compress, i.e., due to the undercut portion 3a the upper portion 3b was lifted up instead of compressing.

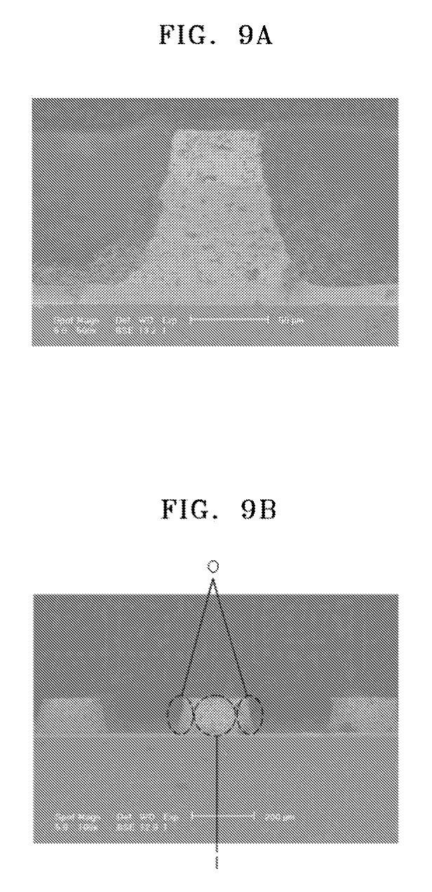

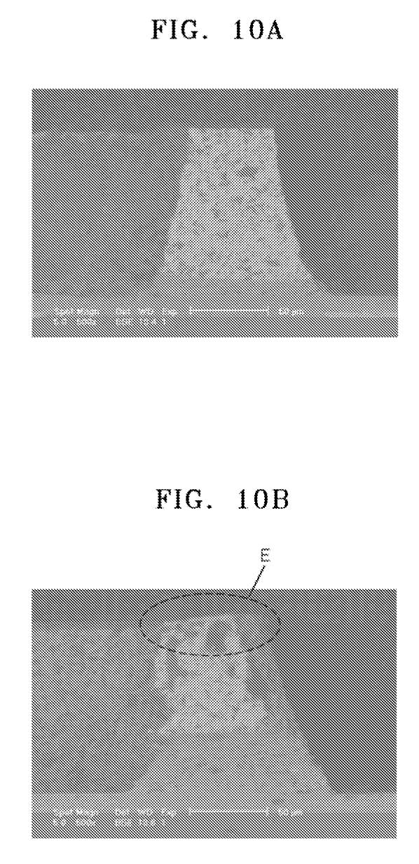

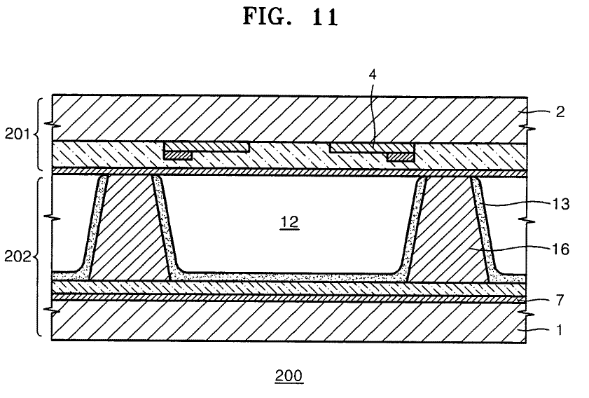

FIGS. 9A-9B illustrate SEM images of cross-sections of inner and dummy barrier ribs, respectively, formed according to Example 1. FIG. 9A illustrates a 500-times enlarged SEM image of the inner barrier ribs, and FIG. 9B illustrates a 100-times enlarged SEM image of the dummy barrier ribs. FIGS. 10A-10B illustrate SEM images of cross-sections of inner and dummy barrier ribs, respectively, formed according to Comparative Example 1.

As can be seen in FIGS. 10A-10B, height of the inner barrier ribs was 120 μm and height of the dummy barrier ribs was 130 μm. In other words, the barrier ribs of the second PDP had a non-uniform height because end portions of the dummy barrier ribs protruded upward, as indicated by an area E, to increase a height of the dummy barrier ribs. As can be seen in FIGS. 9A-9B, height of the inner barrier ribs was 118 μm and height of the dummy barrier ribs was 117 μm. In other words, the barrier ribs of the first PDP had a substantially uniform height, and this means that end portions of the dummy barrier ribs were not lifted upwards during baking. As further illustrated in FIG. 9B, a central part I has a lighter color than peripheral parts O, thereby indicating that parts O are convex.

As described above, formation of dummy barrier ribs according to embodiments of the present invention may be advantageous by preventing protrusion of edges of barrier ribs in an upward direction, thereby improving attachment of the front and rear panels to each other to reduce vibration and noise during operation of the PDP.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel (PDP), comprising:
a first substrate;
a second substrate facing the first substrate;
inner barrier ribs in a display region of the PDP between the first substrate and the second substrate to define discharge cells;
at least one dummy barrier rib in a non-display region of the PDP between the first substrate and the second substrate, the non-display region being external to the display region, and the dummy barrier rib including at least one curved end portion and a cavity in the curved end portion;
discharge electrodes between the first substrate and the second substrate to generate a discharge in the discharge cells; and
at least one phosphor layer in each discharge cell.

2. The PDP as claimed in claim 1, wherein the curved end portion of the dummy barrier rib has an oval shape, and the cavity is in a center of the curved end portion.

3. The PDP as claimed in claim 1, wherein the curved end portion of the dummy barrier rib has an oval shape, and the cavity is off-centered.

4. The PDP as claimed in claim 3, wherein the cavity is between a center of the curved end portion and a linear body attached to the curved end portion.

5. The PDP as claimed in claim 1, wherein the curved end portion of the dummy barrier rib has a circular shape, and the cavity is in a center of the curved end portion or between the center and a linear body attached to the curved end portion.

6. The PDP as claimed in claim 1, further comprising a plurality of dummy barrier ribs in parallel to one another, the curved end portions of the dummy barrier ribs being aligned horizontally or vertically.

7. The PDP as claimed in claim 1, further comprising a plurality of dummy barrier ribs in parallel to one another, the curved end portions of the dummy barrier ribs being arranged in a zigzag.

8. The PDP as claimed in claim 1, further comprising a plurality of dummy barrier ribs in parallel to one another, the curved end portions of the dummy barrier ribs being arranged in a diagonal line.

9. The PDP as claimed in claim 1, wherein the curved end portion of the dummy barrier rib is attached to a linear body, a width of the curved end portion being greater than a width of the linear body.

10. The PDP as claimed in claim 1, wherein the curved end portion of the dummy barrier rib is attached to a linear body, heights of the curved end portion and the linear body being substantially equal.

11. The PDP as claimed in claim 1, further comprising a plurality of dummy barrier ribs in parallel to one another, a width of an outermost dummy barrier rib being greater than a width of each of the other dummy barrier ribs.

12. A mask for forming barrier ribs of a plasma display panel (PDP), comprising at least one barrier rib pattern, the barrier rib pattern including,
a linear body;
at least one curved end portion attached to the linear body; and
a cavity in the curved end portion.

13. A method of forming a plasma display panel (PDP), comprising:
forming inner barrier ribs in a display region of the PDP between facing first and second substrates to define discharge cells;
forming at least one dummy barrier rib in a non-display region of the PDP between the first and second substrates, the non-display region being external to the display region, and the dummy barrier rib including at least one curved end portion and a cavity in the curved end portion;
forming discharge electrodes between the first and second substrate; and
forming at least one phosphor layer in each discharge cell.

14. The method as claimed in claim 13, wherein forming the dummy barrier rib includes forming a plurality of dummy barrier ribs in a stripe pattern.

15. The method as claimed in claim 13, wherein forming the dummy barrier rib includes,
shaping the curved end portions of the dummy barrier ribs to have oval shapes or circular shapes; and
forming the cavity in a center of the curved end portion or between the center and a linear body attached to the curved end portion.

16. The method as claimed in claim 13, wherein forming the dummy barrier rib includes forming a dummy barrier rib patterning mask on a barrier rib material, the dummy barrier rib patterning mask including at least one curved end portion and a cavity in the curved end portion.

17. The method as claimed in claim 16, wherein forming the dummy barrier rib further comprises,
removing portions of the barrier rib material surrounding the dummy barrier rib patterning mask, such that portions of the barrier rib material under the dummy barrier rib patterning mask is shaped to correspond to the dummy barrier rib patterning mask; and
removing the dummy barrier rib patterning mask.

18. The method as claimed in claim 16, wherein forming the dummy barrier rib patterning mask includes forming a plurality of patterns with curved end portions, the curved end portions being aligned vertically, horizontally, diagonally or in a zigzag.

19. The method as claimed in claim 16, wherein forming the dummy barrier rib patterning mask includes forming a plurality of patterns with curved end portions, a width of each curved end portion being larger than a width of any other portion of a respective pattern.

20. The method as claimed in claim 16, wherein forming the dummy barrier rib patterning mask includes forming a plurality of patterns, a width of an outermost pattern of the plurality of patterns being greater than a width of any other pattern.
